(19) United States
(12) Patent Application Publication
(10) Pub. No.: US 2012/0297104 A1
(43) Pub. Date: Nov. 22, 2012

(54) CONTROLLED INTERMEDIATE BUS ARCHITECTURE OPTIMIZATION

(75) Inventors: Vijayan J. Thottuvelil, Addison, TX (US); Michael J. Model, Sachse, TX (US); Allen F. Rozman, Garland, TX (US); Karim Wassef, Garland, TX (US); Richard Hock, Farmersville, TX (US)

(73) Assignee: General Electric, Schenectady, NY (US)

(21) Appl. No.: 13/461,370

(22) Filed: May 1, 2012

Related U.S. Application Data
(60) Provisional application No. 61/488,440, filed on May 20, 2011.
(60) Provisional application No. 61/488,450, filed on May 20, 2011.

(51) Int. Cl. G06F 13/14

(52) U.S. Cl. 710/305

(57) ABSTRACT

An intermediate bus architecture power system includes a bus converter that converts an input voltage into a bus voltage on an intermediate bus and a point-of-load converter that supplies an output voltage from the bus voltage on the intermediate bus. Additionally, the intermediate bus architecture power system includes a decision engine optimizing controller that controls a system variable to improve an overall system performance based on a monitored system variable or a system constraint. In another aspect, a method of operating an intermediate bus architecture power system includes converting an input voltage into a bus voltage on an intermediate bus and converting the bus voltage on the intermediate bus into an output voltage. The method also includes controlling a system variable to improve overall system performance based on a monitored system variable or a system constraint.

### CROSS-REFERENCE TO RELATED APPLICATION

This application claims the benefit of U.S. Provisional Application Ser. No. 61/488,440, filed by Vijayan Joseph Thottuvelil, Michael Model, Allen Rozman and Karim Wassef on May 20, 2011, entitled “Bus Conversion System Optimizer”, commonly assigned with this application and incorporated herein by reference.

This application also claims the benefit of U.S. Provisional Application Ser. No. 61/488,450, filed by Richard Hock on May 20, 2011, entitled “Controlled Intermediate Bus Architecture For Optimized Efficiency”, commonly assigned with this application and incorporated herein by reference.

### TECHNICAL FIELD

This application is directed, in general, to power conversion and, more specifically, to an intermediate bus architecture power system and a method of operating an intermediate bus architecture power system.

### BACKGROUND

Intermediate bus power systems typically include a bus converter that provides a DC bus voltage to a plurality of point-of-load converters (POLs) through an intermediate bus structure. Each of the plurality of POLs provides a separate output voltage to a load that may be variable with time. One skilled in the art is able to recognize that POLs may be modularized or discrete implementations and may also provide a plurality of output voltages to multiple loads. Overall system efficiency is proportional to the efficiency of the bus converter as well as that of the plurality of POLs employed. This overall system efficiency is dependent upon many factors including a DC input voltage and the DC bus voltage as well as design and operating characteristics of the bus converter and POLs. Therefore, optimization of the overall system efficiency is complex and dependent on a variety of factors. Improvements in this area would prove beneficial to the art.

### SUMMARY

Embodiments of the present disclosure correspond to an intermediate bus architecture power system and a method of operating an intermediate bus architecture power system.

In one embodiment, the intermediate bus architecture power system includes a bus converter that converts an input voltage into a bus voltage on an intermediate bus, and a point-of-load converter that supplies an output voltage from the bus voltage on the intermediate bus. Additionally, the intermediate bus architecture power system includes a decision engine optimizing controller that controls a system variable to improve an overall system performance based on a monitored system variable or a system constraint.

In another aspect, the method of operating an intermediate bus architecture power system includes converting an input voltage into a bus voltage on an intermediate bus and then converting the bus voltage on the intermediate bus to an output voltage. The method also includes controlling a system variable to improve overall system performance based on a monitored system variable or a system constraint.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

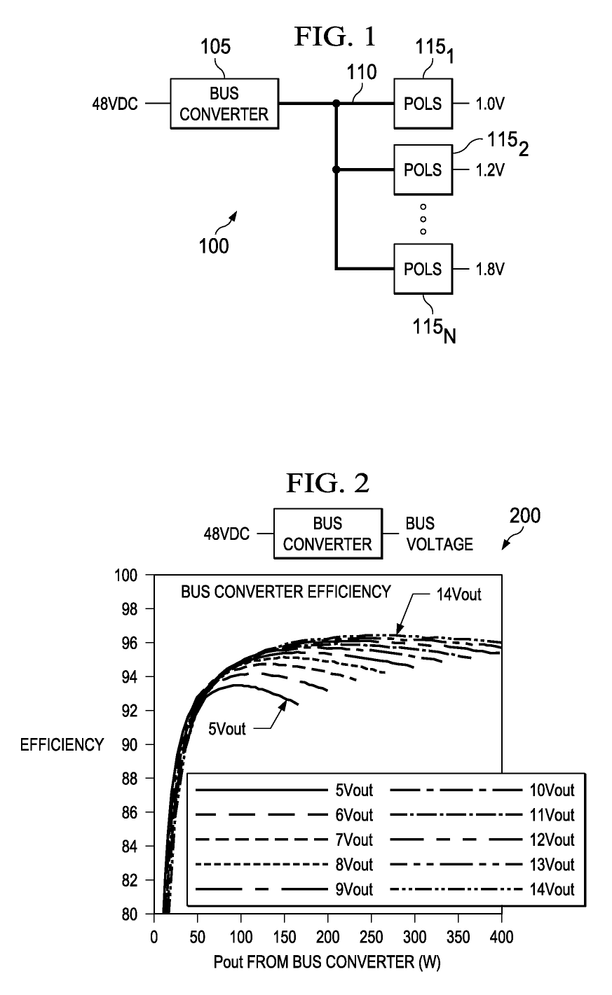

FIG. 1 illustrates a simplified block diagram of an intermediate bus power system, which may be employed to examine various general characteristics of intermediate bus architectures.

FIG. 2 illustrates a family of efficiency curves for a typical 48 volt input, 400 watt converter at various output voltages.

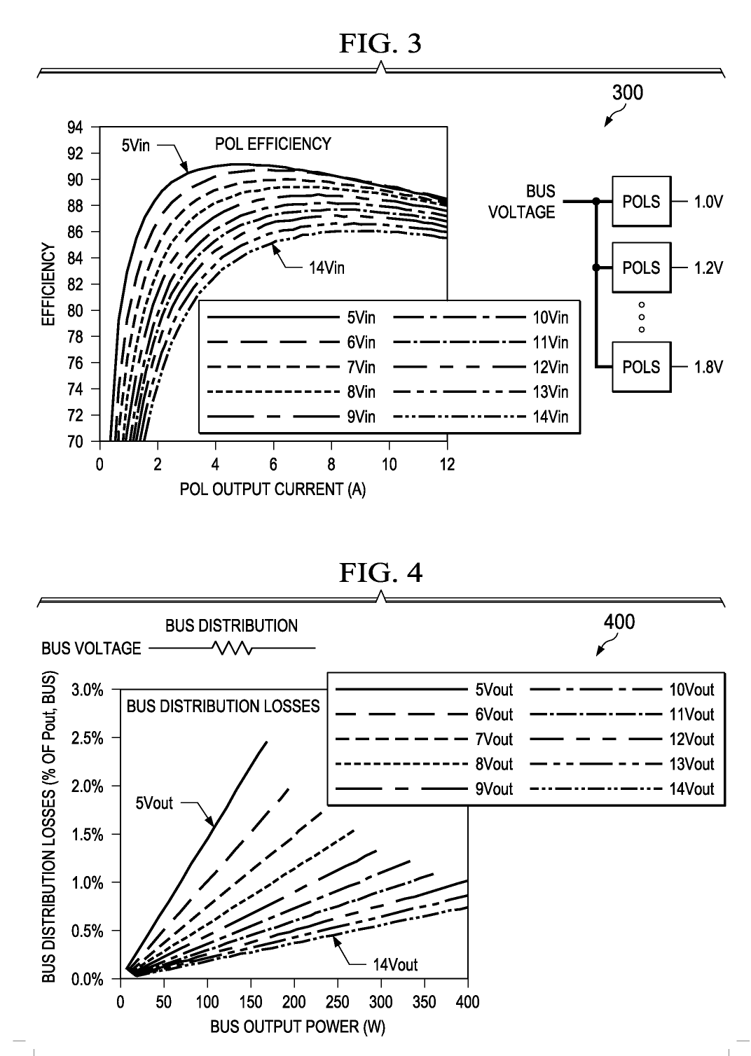

FIG. 3 illustrates an exemplary set of efficiency curves for a point-of-load (POL) converter generally showing increased efficiency characteristics as a function of lower intermediate bus voltage.

FIG. 4 illustrates an example of intermediate bus loss characteristics due to various bus distribution losses.

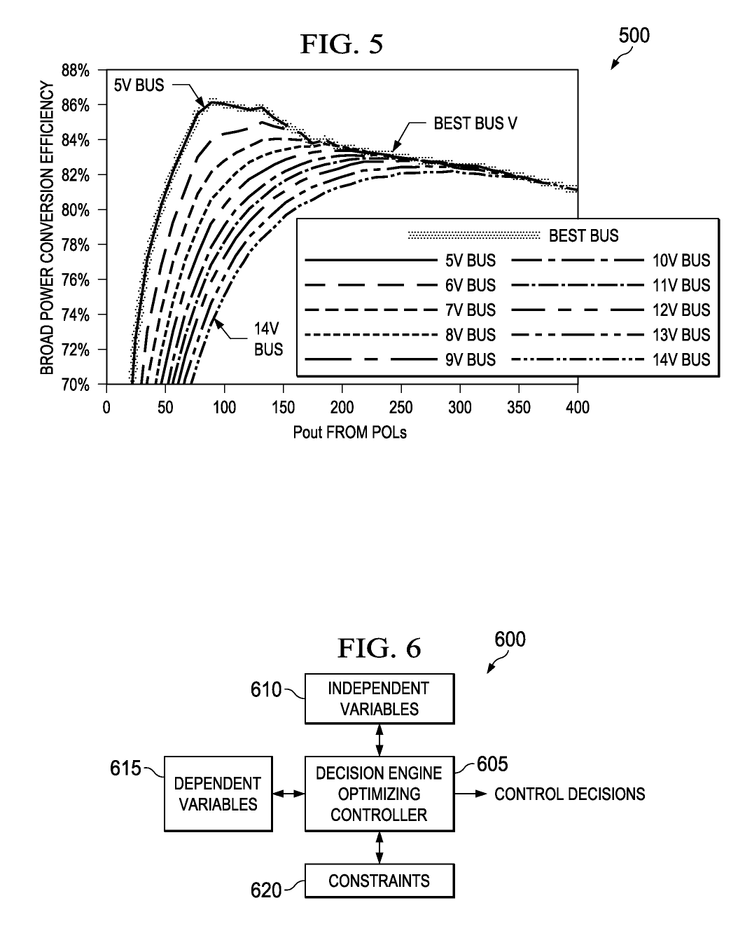

FIG. 5 illustrates a broad power conversion efficiency, generally designated 500, which combines previous efficiency characteristics discussed with respect to FIGS. 2, 3 and 4.

FIG. 6 illustrates a block diagram of an embodiment of a decision-based controller constructed according to the principles of the present disclosure;

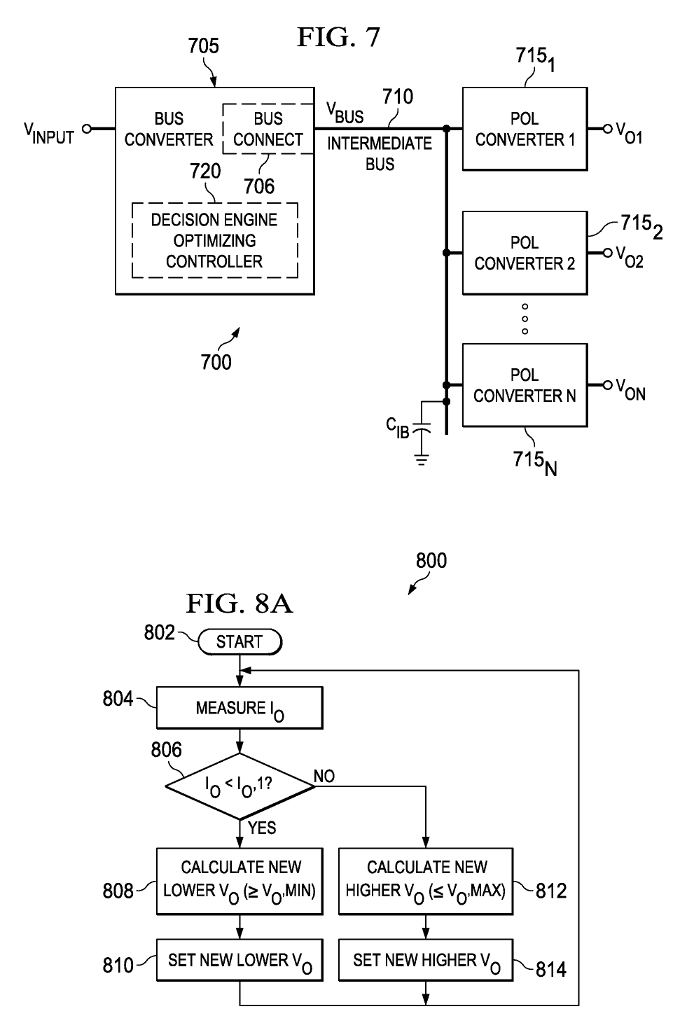

FIG. 7 illustrates a block diagram of an embodiment of an intermediate bus architecture power system constructed according to the principles of the present disclosure;

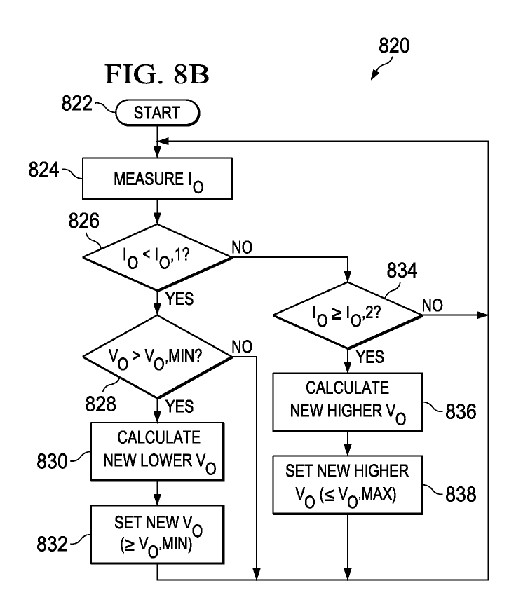

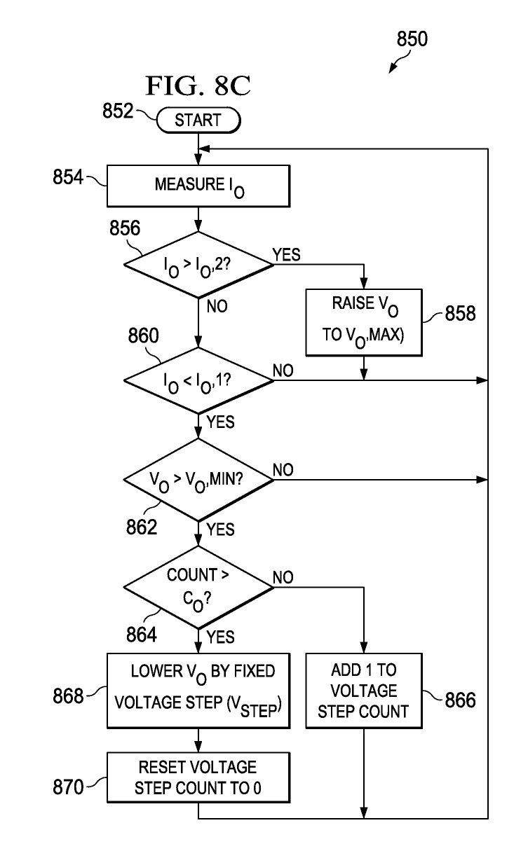

FIGS. 8A, 8B and 8C illustrate flow diagrams of embodiments of methods of efficiency optimization, generally designated 800, 820, 850, for an intermediate bus architecture power system carried out according to the principles of the present disclosure.

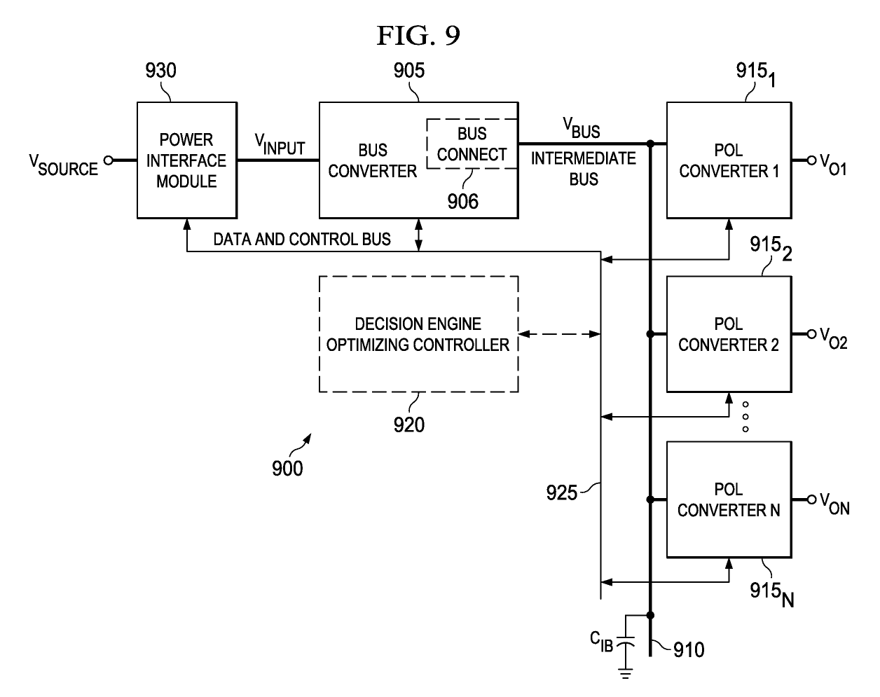

FIG. 9 illustrates a diagram of another embodiment of an intermediate bus architecture power system constructed according to the principles of the present disclosure;

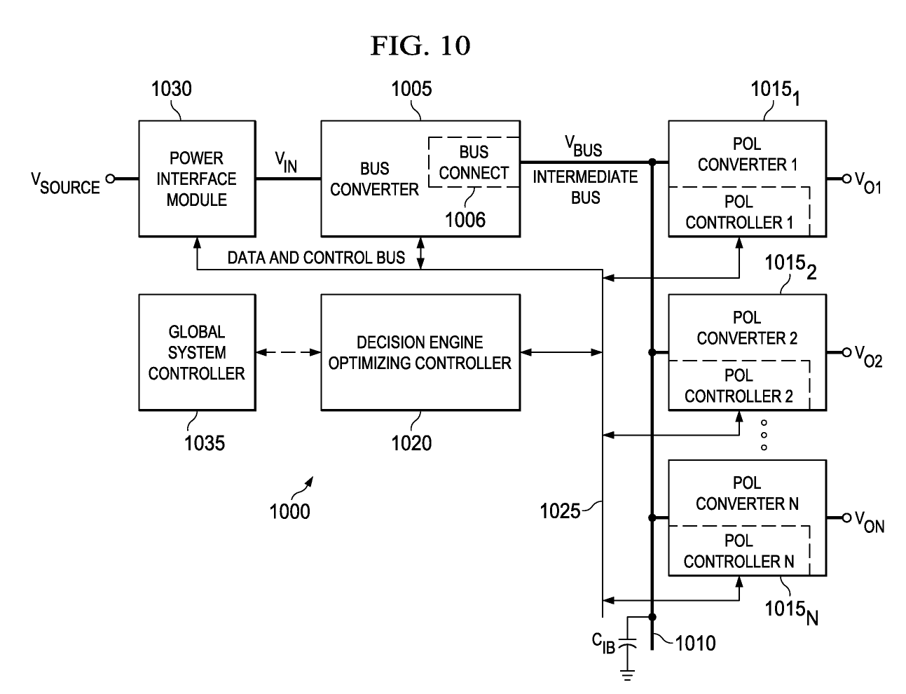

FIG. 10 illustrates a block diagram of yet another embodiment of an intermediate bus architecture power system constructed according to the principles of the present disclosure;

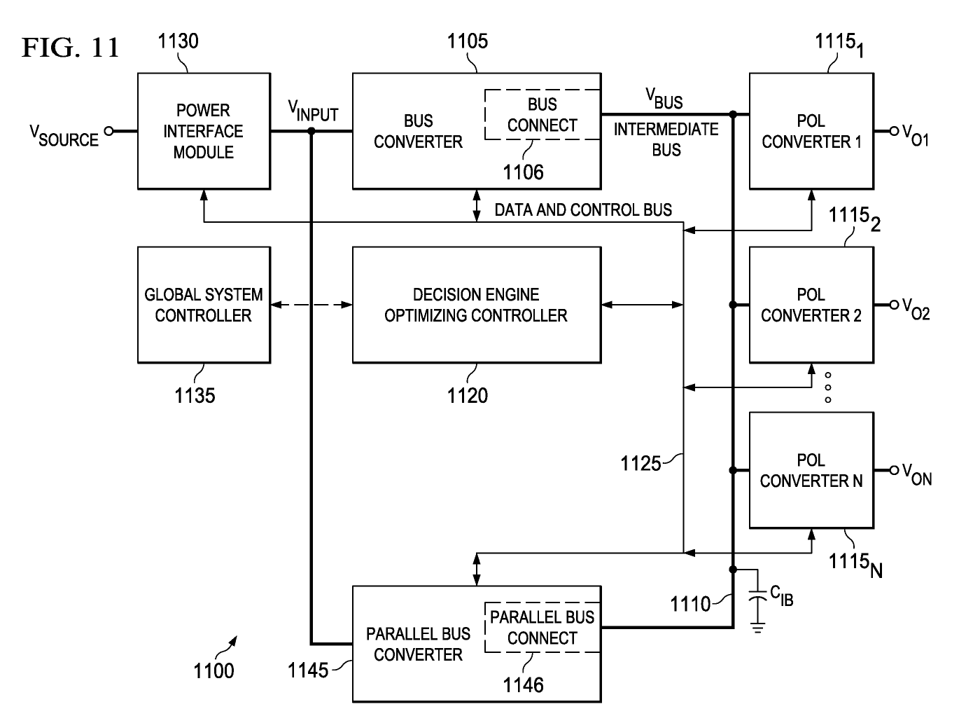

FIG. 11 illustrates a block diagram of still another embodiment of an intermediate bus architecture power system constructed according to the principles of the present disclosure; and

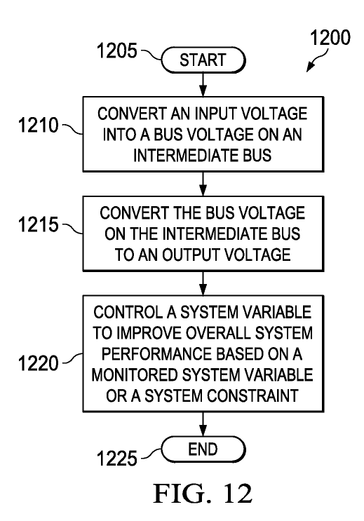

FIG. 12 illustrates a flow diagram of an embodiment of a method of operating an intermediate bus architecture power system carried out according to the principles of the present disclosure.

### DETAILED DESCRIPTION

For DC power systems having power capabilities of at least 50 watts, a bus converter is often used to create an intermediate bus voltage that supplies a plurality of point-of-load converters (POLs), which in turn provide a plurality of output voltages to separate loads. FIG. 1 illustrates a simplified block diagram of an intermediate bus power system, generally designated 100, which may be employed to examine various general characteristics of intermediate bus architectures. The intermediate bus power system 100 includes a bus converter 105 that employs an input voltage (e.g., 48 volts DC) to provide an intermediate bus voltage on an intermediate bus 110. The intermediate bus power system 100 also includes a plurality of POLs 115₁-115_{N} that provide N independently regulated DC output voltages (e.g., 1.0 volts, 1.2 volts, etc.), as shown.

In general, the efficiency of a bus converter will increase as its bus output voltage increases for a constant input voltage. For example, a 12 volt output bus voltage converter will be more efficient than a six volt output bus voltage converter, since, for a constant power level, the six volt bus voltage converter supplies twice the output current of the 12 volt bus voltage converter thereby increasing resistive losses, which leads to lower overall efficiency.

FIG. 2 illustrates a family of efficiency curves, generally designated 200, for a typical 48 volt input, 400 watt converter at various output voltages. It is evident, except at very light loads, that the bus converter operates more efficiently for a given output power as its output voltage is increased. Additionally, higher losses incurred at lower output voltages limit the available output power as well. For example, if an output current from the bus converter is limited to 33 amperes, a five volt output bus converter can only supply approximately 165 watts, while that same converter can deliver 400 watts at 12 volts output.

FIG. 3 illustrates an exemplary set of efficiency curves for a POL converter, generally designated 300, showing increased efficiency characteristics as a function of lower intermediate bus voltage. The efficiency characteristics of the POL converter are a function of its output voltage, its load current and the bus voltage supplying the POL converter input. In contrast to the bus converter, the efficiency of a POL converter increases with decreasing bus voltage. So, furnishing a lower bus voltage to the POL converter increases its efficiency while the bus converter operates more efficiently with a higher bus voltage.

A third factor in generating losses is due to bus distribution resistances. FIG. 4 illustrates an example of intermediate bus loss characteristics, generally designated 400, due to various bus distribution losses. As may be seen by examining the loss characteristics 400, distribution losses increase as bus voltage decreases due to the increased current that may be supplied to a required load.

Combining the previously discussed efficiency characteristics yields an exemplary overall efficiency characteristic. FIG. 5 illustrates a broad power conversion efficiency, generally designated 500, which combines previous efficiency characteristics discussed with respect to FIGS. 2, 3 and 4. In this example, the best overall efficiency is derived by operating at the lowest bus voltage, which in this case is five volts. However at this output voltage, only 165 watts (5V at 33 A) can be obtained from the output of the bus converter since the bus converter will limit its output current. In this simple example, adjusting the bus voltage from five volts at light load to 14 volts at maximum load provides a system with optimized efficiency. Of course, other examples may exhibit different sets of efficiency curves.

Optimizing system efficiency is complicated further when utilizing unregulated bus converters since the bus voltage varies with input voltage and load current. Furthermore, although an unregulated bus converter may itself have a somewhat inherent higher efficiency than that of a regulated bus converter, the “uncontrolled” bus voltage it supplies may result in an overall power system efficiency that is lower than a power system using a regulated bus converter with an optimized bus voltage.

Embodiments of the present disclosure utilize a decision engine optimizing controller that controls a system variable to improve an overall system efficiency based on a monitored system variable or a system constraint. This provides optimization of an overall efficiency of an intermediate bus power system as compared to efficiency optimization of each constituent part of the intermediate bus power system. This overall efficiency optimization may be achieved even if some constituent parts of the intermediate bus power system operate at less than their maximum achievable efficiency. Operating power system data and operational characteristics of the constituent parts may be initially stored or measured in real time for use in optimizing the overall efficiency.

Control of the intermediate bus power system may be provided by a local controller that is integral with one or more of the constituent parts (e.g., the bus converter) or a standalone controller. The local controller may also operate in conjunction with a global system controller or some combination of the three embodiments.

Additionally, multiple bus converters may be employed to provide an intermediate bus voltage and share an intermediate bus current to a plurality of POL converters. At least one of these bus converters is a regulated bus converter while others may be regulated or unregulated.

FIG. 6 illustrates a block diagram of an embodiment of a decision-based controller, generally designated 600, constructed according to the principles of the present disclosure. The decision-based controller 600 includes a decision engine optimizing controller 605 that employs independent variables 610, dependent variables 615 and system constraints 620 to provide control decisions for a corresponding system. The decision engine optimizing controller 605 employs a decision engine that is used to determine how to change the independent variables 610 in response to monitored dependent variables 615 or the system constraints 620. In one embodiment, the decision engine employs a series of logical operations and mathematical calculations based on one dependent variable and impacting one independent variable. In a more general embodiment, any number of dependent and independent variables may be considered along with the system constraints.

The decision engine optimizing controller 605 may include part of a digital controller used to perform regulation and control of a bus converter, for example. More specifically, the decision engine optimizing controller 605 may include an algorithm or algorithms embodied in computer code executing on a digital controller integrated circuit (IC), for example. The digital controller IC may include a single digital controller executing both the decision engine optimizing controller 605 algorithms and the regulation and control of a bus converter. Alternatively, the digital controller IC may include multiple digital control ICs executing the bus converter regulation, control and the decision engine optimizing controller.

In general, the illustrated embodiment of FIG. 6 and related embodiments to be discussed have a number of variables that are independent of or dependent on a control architecture employed. Independent variables are defined, for the purposes of this disclosure, as those variables that can be directly controlled. Correspondingly, dependent variables are defined, for the purposes of this disclosure, as those variables that are monitored to determine if a desired result has been achieved, for example.

Generally, a number of variables may be employed as independent variables that are controlled within an embodiment of the present disclosure employing a decision engine optimizing controller. Independent variable examples, corresponding to any member of a power solution of a related embodiment, may include an output voltage (such as a bus voltage), a switching frequency or phase (of any member of the power solution), a switch timing (of any component of any member of the power solution), a gate drive voltage (of any component of any member of the power solution), a number of switching devices enabled (of any member of the power solution), a number of switching stages enabled (of any member of the power solution) or an actively generated perturbation. One skilled in the art is able to recognize other independent variables that may likewise be controlled within an embodiment of the present disclosure.

A number of variables may also be used as dependent variables that are monitored by an embodiment of the present disclosure employing a decision engine optimizing controller and may or may not be used in a decision to make a change to an independent variable. Dependent variable examples, corresponding to any member of the power solution of a related embodiment, may include an output current, an efficiency, a power dissipation, an electromagnetic interference (EMI), an output ripple, a transient response, a temperature, a current share signal or a response to an actively generated perturbation. Again, one skilled in the art is able to recognize other variables that may likewise be monitored within an embodiment.

Additionally, system constraints may be employed in a decision to make or limit a change to an independent variable. System constraints may also limit changes to a dependent variable. The constraints include pre-set conditions that are established prior to system operation as well as user-set constraints that are those changes made by a user to affect system operation. In situ constraints are those constraints inherent in system operation, where alarms may be viewed as a special case of in situ system constraints. Additionally, adaptive constraints occur as a system adapts its functionality during system operation. Also, one skilled in the art is able to recognize specific constraints within these categories or other constraints that may be applicable within an embodiment.

In the example of an independent variable being a bus voltage, a corresponding dependent variable is a bus current since it is partially dependent on the bus voltage. The bus voltage may be changed so that the bus current meets requirements set by system constraints, for example. Another dependent variable is a system efficiency that may be indirectly improved (relative to a static bus voltage) as a result of new bus voltage and bus current variables.

Additionally, an independent variable may be an actively generated perturbation, and one or more dependent variables may be the response to the actively generated perturbation. Alternately, the independent and dependent variables may employ passive system characteristics. Also, a mix of actively generated perturbations and passive system characteristics may constitute independent and dependent variables.

An independent variable may also be used as a dependent variable. An example of this is a bus voltage that is determined by a decision engine optimizing controller, but that may change due to other influences and would therefore need to be monitored. In this case, it would be a dependent variable and the controller may enact a change to influence it as an independent variable. Dependent variables may also be directly or indirectly monitored. Examples of this would be a bus current as a direct dependent variable and a system efficiency as an indirect dependent variable.

A decision engine optimizing controller may monitor a bus converter's temperatures, currents and power dissipation. Based on these dependent variables, the decision engine optimizing controller may establish a bias in bus voltage or switching frequency and phase to minimize a figure of merit based on the dependent variables. For example, independent and dependent variables to improve a thermal distribution between multiple bus converters in parallel may employ independent variables of bus switching frequency and phase along with the bus voltage. Corresponding dependent variables may include bus converter power dissipation, bus converter temperature and bus converter output current.

A decision engine optimizing controller may monitor a change in a system characteristic over time and respond to it. For example, a bus distribution loss may change due to degradation over time (e.g., due to environmental corrosion). In this case, a constraint such as a maximum bus voltage may be changed to compensate for this degradation.

FIG. 7 illustrates a block diagram of an embodiment of an intermediate bus architecture power system, generally designated 700, constructed according to the principles of the present disclosure. The intermediate bus architecture power system 700 includes a bus converter 705, having a bus connection 706, that converts a DC input voltage V_{INPUT} into a DC bus voltage V_{BUS} on an intermediate bus 710. The intermediate bus architecture power system 700 also includes a plurality of point-of-load converters (POLs) 715₁, 715₂, . . . , 715_{N} having inputs connected to the intermediate bus 710, that supplies a corresponding plurality of output voltages V_{O1}, V_{O2}, . . . , V_{ON} from the bus voltage V_{BUS}.

The intermediate bus architecture power system 700 further includes a decision engine optimizing controller 720 that is embedded in and thereby coupled to the bus converter 705 and controls a system variable to improve overall system performance based on a monitored system variable or system constraint. The decision engine optimizing controller 720 may include part of a digital controller used to perform regulation and control of a bus converter, for example. More specifically, the decision engine optimizing controller 720 may include an algorithm or algorithms embodied in computer code executing on a digital controller IC, for example. The digital controller IC may include a single digital controller executing both the decision engine optimizing controller 720 algorithms and the regulation and control of a bus converter. Alternatively, the digital controller IC may include multiple digital control ICs executing the bus converter regulation, control and the decision engine optimizing controller.

There are several advantages to the bus converter 705 being able to autonomously adjust the bus voltage V_{BUS}. First, no external controller is needed, since in this embodiment, the decision engine optimizing controller 720 (i.e., at least its functionality and intent) has been integrated into the bus converter 705. In fact, this approach can be used in different types of bus converters, ranging from ones using only analog interfaces and analog control, to a fully digital bus converter (including interfaces and control). Second, since no external controller is needed, design and development are simplified. This may be expected to greatly increase an adoption level of efficiency improvement schemes that utilize bus voltage modulation with system loading. Third, this scheme provides backward footprint convertibility with existing sockets where an existing bus converter is being replaced. Specifically, in existing applications a significant efficiency boost over fully regulated analog converters can be obtained by using a combination of analog interfaces and digital control. Retrofit options are also supported allowing for energy and cost savings.

The bus connection 706 provides a controllable connection between the bus converter 705 and the intermediate bus 710 consisting of one or a plurality of parallel switches (e.g., field effect transistors (FETs)) that are separately controllable. This capability allows modification of a switch resistance for the bus connection 706. Alternatively, the bus connection 706 may include a simple low impedance soldered or connectorized connection to improve system efficiency.

In the illustrated embodiment, the bus converter 705 contains the decision engine optimizing controller 720 and autonomously (i.e., without any communication from an external controller) may vary the bus voltage V_{BUS} to optimize an efficiency of the intermediate bus architecture power system 700. This may be accomplished by the bus converter 705 measuring, for example, its output current and setting the bus voltage V_{BUS} autonomously to a level that improves a system power conversion efficiency over what would be met by operating at a fixed bus voltage while meeting the demands of a load to deliver needed power up to a design maximum (i.e., a constraint). The algorithm in the decision engine optimizing controller 720 may, for example, be enabled automatically when the bus converter 705 is powered up, or alternatively, it may be disabled when the bus converter 705 is powered up. If it is disabled, a user may enable the algorithm in the decision engine optimizing controller 720 by communicating with the bus converter via a digital communication bus, for example. Alternately, a pin of the bus converter 705 may be employed by the user to indicate whether the bus voltage variation algorithm is to be enabled or not.

Additionally, other embodiments may provide communication between the bus converter 705 and the POLs 715₁, 715₂, . . . , 715_{N} through the bus voltage V_{BUS} (i.e., employing the intermediate bus 710 as a communication bus) for use by the integral decision engine optimizing controller 720. For example, the intermediate bus voltage V_{BUS} may be modulated to carry digital or analog information between the bus converter 705 and at least one of the POL converters 715₁, 715₂, . . . , 715_{N}.

The bus converter 705 may also employ additional approaches to improve system efficiency as a function of an operational characteristic (e.g., including, but not limited to, an output current, an input current, an output power, an input power, an input voltage, etc.). For example, the bus converter 705 may adjust its switching frequency as a function of an operational characteristic. Additionally, it may be advantageous to reduce a switching frequency at lower output power levels in order to further improve efficiency.

Another approach to improving efficiency as a function of an output characteristic may be for the bus converter 705 to adaptively adjust the timing between its various power switches. In particular, timing adjustment between primary referenced power switches and secondary referenced synchronous rectifiers may be employed. Yet another approach to improving efficiency as a function of an output characteristic is for the bus converter 705 to adaptively adjust a level of gate drive of one or more power switches. These examples of additional methods of efficiency improvement are intended to be illustrative and not limiting.

An exemplary idea in these efficiency improvement schemes is to have the bus converter 705 always operate at the lowest possible bus voltage V_{BUS} (or a best switching frequency, a best switch timing relationship, a best gate drive voltage, etc.) consistent with meeting the condition that the output current drawn satisfies its design constraints.

FIGS. 8A, 8B and 8C illustrate flow diagrams of embodiments of methods of efficiency optimization, generally designated 800, 820, 850, for an intermediate bus architecture power system carried out according to the principles of the present disclosure. Generally, the methods 800, 820 and 850 may be applied to control decisions provided by embodiments of decision engine optimizing controllers as discussed with respect to this disclosure.

In one example, these methods may be implemented as part of a bus converter (e.g., the bus converter 705 of FIG. 7), either digitally, using analog circuitry or a combination of both. Digital implementation may be a preferred embodiment as it typically offers more flexibility. Several key parameters may be established, either as values stored in the bus converter during its manufacturing test, or as values changed or stored though a digital interface such as a power management bus. This may occur before the bus converter is assembled or after assembly, and before the bus converter is required to operate delivering output power.

Examples of these parameters include a single bus converter output current threshold Io,1 around which a bus voltage Vo (e.g., the DC bus voltage V_{BUS} on the intermediate bus 710 of FIG. 7) may be adjusted to optimize efficiency. Additionally, the parameters may include a first bus converter output current threshold Io,1 below which a bus voltage Vo can be reduced for improving efficiency, and a second bus converter output current threshold Io,2 above which the bus voltage Vo needs to be raised to avoid exceeding the maximum rated bus converter current capability Io,max based on minimum and maximum allowed bus converter output voltages Vo,min, Vo,max. In this case, Io,1 may be selected to be 70 percent of Io,max, and Io,2 may be selected to be 85 percent of Io,max, for example.

The method 800 employs a single bus converter output current threshold Io,1 and starts in a step 802. Then, in a step 804, an output current Io supplied by an intermediate bus is measured. A decisional step 806 determines if the output current Io is less than the bus converter output current threshold Io,1. If it is less, a new, lower output voltage Vo that is greater than or equal to a minimum allowed bus converter output voltage Vo,min is calculated, in a step 808. This new, lower output voltage Vo is set in a step 810, and the method returns to the step 804. If the output current Io is not less than the bus converter output current threshold Io,1 in the step 806, a new, higher output voltage Vo is calculated that is less than or equal to a maximum allowed bus converter output voltage Vo,max, in a step 812. This new, higher output voltage Vo is set in a step 814, and the method 800 again returns to the step 804, where the output current Io continues to be measured and the output voltage Vo correspondingly adjusted.

The method 820 employs first and second bus converter output current thresholds Io,1 and Io,2 and starts in a step 822. Then, in a step 824, an output current Io supplied by an intermediate bus is measured. A decisional step 826 determines if the output current Io is less than the first bus converter output current threshold Io,1. If it is less, a decisional step 828 determines if an output voltage Vo is greater than a minimum allowed bus voltage, Vo,min. If the output voltage Vo is not greater than the minimum allowed bus voltage Vo,min, the method 820 returns to the step 824 where the output current Io continues to be measured.

If the decisional step 828 determines that the output voltage Vo is greater than the minimum allowed bus voltage, Vo,min, a new, lower output voltage Vo is calculated wherein the new, lower output voltage Vo equals (Vo×Io)/(Io,1) subject to it being greater than or equal to the minimum allowed bus voltage, Vo,min in a step 830 and set in a step 832. The method 820 again returns to the step 824 where the output current Io continues to be measured.

If the output current Io is not less than the first bus converter output current threshold Io,1 in the decisional step 826, a decisional step 834 determines if the output current Io is greater than or equal to the second bus converter output current threshold Io,2. If the output current Io is not greater than or equal to the second bus converter output current threshold Io,2, the method 820 again returns to the step 824 where the output current Io continues to be measured.

If the output current Io is greater than or equal to the second bus converter output current threshold Io,2, a new, higher output voltage Vo is calculated wherein the new, higher output voltage Vo equals (Vo×Io)/(Io,2) subject to it being less than or equal to the maximum allowed bus voltage Vo,max in a step 836 and set in a step 838. The method 820 then returns to the step 824 where the where the output current Io continues to be measured and the output voltage Vo correspondingly adjusted.

The method 850 also employs first and second bus converter output current thresholds Io,1 and Io,2 as well as output voltage modification employing discrete output voltage steps. The method 850 starts in a step 852, and an output current Io is measured, in a step 854. Then, a decisional step 856 determines if the output current Io is greater than the second bus converter output current threshold Io,2. If it is greater, an output voltage Vo is raised to a maximum allowed bus voltage Vo,max, and the method 850 returns to the step 854.

If the output current Io is not greater than the second bus converter output current threshold Io,2, a decisional step 860 determines if the output current Io is less than the first bus converter output current threshold Io,1. If it is not less, the method 850 again returns to the step 854. If it is less, a decisional step 862 determines if the output voltage Vo is greater than a minimum allowed bus voltage Vo,min. If it is not greater, the method 850 again returns to the step 854. If it is greater, a decisional step 864 determines if a voltage step count is greater than a step count limit value Co. If the voltage step count is not greater than the step count limit value Co, the voltage step count is increase by one in a step 866, and the method 850 returns to the step 854. If the voltage step count is greater than Co, the output voltage Vo is lowered by a corrective fixed voltage step Vstep, in a step 868. The voltage step count is reset to zero in a step 870, and the method 850 again returns to the step 854.

In particular, the method 850 may offer a reduction in implementation complexity of an output voltage variation scheme for the bus converter 705, for example. Providing variations to the bus voltage V_{BUS} in discrete steps may allow use of a lookup table to determine a new bus voltage V_{BUS} for a certain specified power level or other combination of system variables, and thereby eliminate calculations requiring multiplication or division. Use of discrete bus voltage steps may also minimize the frequency of bus voltage changes thereby reducing the disturbance of bus voltage levels. Use of the decisional step 864 may slow the rate of bus voltage reduction to insure that the system adequately adjusts to a lower bus voltage (and hence a higher bus current).

Bus voltage changes may be implemented with variable step size to accommodate different parameters in an optimization. For example, during reduction of the bus voltage V_{BUS}, smaller step sizes in the bus voltage V_{BUS} may be advantageously used to allow system loads to equilibrate before an eventual bus converter output level is reached. Similarly, following an increase in load power level, the bus voltage V_{BUS} may be ramped up in larger steps in order to quickly accommodate the new load power level.

Many other variations of these exemplary methods are also possible, in addition to being aggressive in increasing bus voltage but lowering bus voltage more gradually by using smaller steps. Utilizing variable ratios for Io,1 and Io,2 over Io,max as a function of other variables such as a bus voltage Vo, temperature, etc. may also be employed to advantage. Additionally, these exemplary methods may be modified by incorporating other parameters or variables. For example, a period T1 may be employed that is related to how often a bus converter current is measured for efficiency optimization (e.g., once every T1 seconds). Alternately, a slew rate S1 at which an output voltage is increased when an output current Io is equal to or greater than Io,2 or a slew rate S2 at which an output voltage Vo is decreased when the output current Io is less than Io,1, are other examples.

Furthermore, a change in the bus voltage V_{BUS} may be achieved by slewing the bus voltage V_{BUS} at lower rates than would trigger an overcurrent condition due to charging of an intermediate bus capacitance C_{IB}. The maximum allowed bus voltage slew rate may be set by a user or determined from pretesting or by programming the value of the capacitance used (e.g., such as during manufacturing test of a system).

Since on-board power conversion systems may vary from unit to unit based on small differences in specific power subsystem characteristics, actual measurements made during test such as during the manufacturing process of either the component modules or the assembled system, may be used to determine optimal settings of a variable such as the bus voltage V_{BUS}. Optimal settings may be a function of one or more power conversion system variables such as output power, module temperatures, etc. Pretesting and characterization allow the use of pre-optimized settings thereby reducing computations involved during actual system use and increasing speed of response to new variable values.

In a power conversion embodiment, such as the intermediate bus architecture power system 700, for example, the bus voltage V_{BUS} may need to be changed to accommodate an increased load level. In certain cases, this increase in load level may occur so rapidly as to exceed an output current limit for the bus converter 705. In order to support this short term increase in load level without shutting down the bus converter 705, its current limit can be increased for a predetermined time period to higher current levels, thereby supporting continued operation of the bus converter 705 in a transient load condition. Such capability may allow more aggressive settings for optimization of the bus voltage V_{BUS}.

It will be obvious to one skilled in the pertinent art that the features and benefits described above for an intermediate bus architecture power system employing an autonomous bus converter (e.g., one having an embedded decision engine optimizing controller) may also be applied to another intermediate bus architecture power system wherein a bus converter employs a decision engine optimizing controller that is standalone and separate from itself.

FIG. 9 illustrates a diagram of another embodiment of an intermediate bus architecture power system, generally designated 900, constructed according to the principles of the present disclosure. The intermediate bus architecture power system 900 includes a bus converter 905, having a bus connection 906, that converts an input voltage V_{INPUT} into a bus voltage V_{BUS} on an intermediate bus 910 having an intermediate bus capacitance C_{IB} connected as shown. The intermediate bus architecture power system 900 also includes a plurality of POL converters (POLs) 915₁, 915₂, . . . , 915_{N} having inputs connected to the intermediate bus 910, that supplies a corresponding plurality of output voltages V_{O1}, V_{O2}, . . . , V_{ON} from the bus voltage V_{BUS}.

The intermediate bus architecture power system 900 further includes a decision engine optimizing controller 920 that controls a system variable to improve overall system performance based on a monitored system variable or system constraint. Additionally, the intermediate bus architecture power system 900 includes a data and control bus 925 that operates as a communications bus and a power interface module 930 connected to a source voltage V_{SOURCE} that provides the input voltage V_{INPUT}.

As before, the bus connection 906 provides a controllable connection of the bus converter 905 to the intermediate bus 910. The bus connection 906 may include one or a plurality of parallel switches (e.g., FETs) wherein each switch is separately controllable to allow modification of a switch resistance for the plurality of parallel switches. Alternatively, the bus connection 906 may include a simple low impedance soldered or connectorized connection to improve system efficiency. The purpose of the power interface module 930 is to condition the source voltage V_{SOURCE} (e.g., to provide filtering of electromagnetic interference, handling of dual source voltage feeds or boosting of the input voltage V_{INPUT} to facilitate ride through) before it is fed to the bus converter 905.

In the illustrated embodiment, the data and control bus 925 is connected between constituent parts of the intermediate bus architecture power system 900 to allow data transfer between all or at least a portion of the constituent parts. Additionally, the decision engine optimizing controller 920 may provide system control of the constituent parts that are controllable through the data and control bus 925. Here, data and control signals are integrated into the data and control bus 925. Alternately, the data and control signals may employ separate busses.

In one case, the decision engine optimizing controller 920 is a standalone system controller that is separate from the other constituent parts. Alternately, the decision engine optimizing controller 920 may be integral to one or more of the other constituent parts, such as the bus controller 905 or one or more of the POLs 915₁, 915₂, . . . , 915_{N}, for example.

In one embodiment, the decision engine optimizing controller 920 operates autonomously in adjusting various parameters within the constituent parts (e.g., the bus voltage V_{BUS} or a frequency or a switch timing) to optimize an overall system efficiency. Each of the constituent parts is in data communication with one or more of the other constituent parts, through the data and control bus 925, as noted. For example, the data and control bus 925 may operate according to an Inter-Integrated Circuit (I2C) communications bus specification. Alternately, other communication busses and bus protocols may be used, including a Controller-Area Network (CAN) bus, a Serial Peripheral Interface (SPI) bus, or any wired, wireless, or optical communication bus approach. Of course, such communication may be two way or one way communication, as required.

In certain embodiments, communication between at least a portion of the constituent parts may be accomplished through the bus voltage V_{BUS}, as before. This may include communication between the bus converter 905 and the POLs 915₁, 915₂, . . . , 915_{N}. As one example, the bus voltage V_{BUS} may be modulated with a higher frequency data signal wherein each of the contributing constituent parts contains a capability to modulate and demodulate the high frequency data signal thereby communicating with the decision engine optimizing controller 920, wherever its location (i.e., standalone or integral). In some embodiments, communicating via the intermediate bus 910 may eliminate the need for a separate data and control bus 925 (e.g., one of the embodiments of FIG. 7 above).

As noted, the decision engine optimizing controller 920 may be integral to one of the constituent parts, for example the bus converter 905, allowing it to monitor system performance and direct the other constituent parts to perform internal adjustments. In this example, the bus converter 905 contains sufficient processing and memory capability to perform as the decision engine optimizing controller 920 in adjusting, for example, the bus voltage V_{BUS} while also instructing one or more of the POLs 915₁, 915₂, . . . , 915_{N} to adjust a switching frequency. Of course, the POLs 915₁, 915₂, . . . , 915_{N} may also be adjusted in other ways.

Each of the constituent parts, (e.g., the POLs 915₁, 915₂, . . . , 915_{N}) can exhibit their own unique performance characteristics. One POL model may exhibit a different efficiency curve when compared to a different POL model. Each of the models may also react differently to other adjustments, such as changes to switch timing or switching frequency. These inherent differences between different POL models may complicate an overall system efficiency optimization and possibly lead to a lower overall efficiency than could otherwise be accomplished if the inherent differences are taken into account.

The decision engine optimizing controller 920, whether standalone or integral, may be configured to read the model numbers of the individual constituent parts (the POLs 915₁, 915₂, . . . , 915_{N}, for example), thereby knowing the particular configuration of the intermediate bus architecture power system 900. The decision engine optimizing controller 920 may then be programmed with the specific representative characteristics of each specific model number and take this information into account when computing the overall efficiency optimization. In this way, the decision engine optimizing controller 920 can adjust each of the constituent parts somewhat differently, thereby typically achieving a better efficiency optimization than it could otherwise accomplish without this information.

For example, an optimal switching frequency may be different for different POLs, depending on specific operating conditions. Additionally, an optimal bus voltage V_{BUS} may also be tailored to optimize efficiency for a specific configuration. Such model-specific information can be stored in the decision engine optimizing controller 920 as a lookup table, for example, or this information may be included as part of a control algorithm employed by the decision engine optimizing controller 920.

Alternatively, each of the constituent parts may have certain aspects of its specific performance characteristics determined at a testing stage, and this information then stored into nonvolatile memory of the constituent part tested. The decision engine optimizing controller 920 can then read this information, along with or instead of the model number, and use the specific performance characteristics in an optimization algorithm. In this way, a higher efficiency may be attained, as the intermediate bus architecture power system 900 can be adjusted and optimized taking into account the actual test characteristics of the constituent parts instead of their representative characteristics.

Additionally, the decision engine optimizing controller 920 may vary the bus voltage V_{BUS} to optimize efficiency by utilizing an algorithm to determine the operating point of maximum efficiency. For example, the decision engine optimizing controller 920 may perform a routine that increments the bus voltage V_{BUS} while monitoring an input current to the intermediate bus architecture power system 900. Then, the bus voltage V_{BUS} would be set at the point of minimum input current. This algorithm may be run periodically or upon command. The algorithm may use averaging or smoothing techniques to avoid responding to transient conditions.

Depending on the processing power of the decision engine optimizing controller 920, an optimization algorithm may exceed the available processor bandwidth particularly if the processor has other tasks to perform, such as loop compensation and duty cycle determination. Therefore, it may be advantageous to use a separate processor within the decision engine optimizing controller 920 to perform the optimization task or to use a separate core in a multi-core processor, for example.

In the intermediate bus architecture power system 900, adjustment of the bus voltage V_{BUS} may be advantageously preceded by load power information provided directly by a load. This allows the bus voltage V_{BUS} to be adjusted to optimally correspond to the new load power level in advance of the load actually changing to the new level. The information from the load may be provided directly to the decision engine optimizing controller 920 wherever it is located.

It is well understood that elevated operating temperatures reduce electronic device lifetimes and lower device reliability. An operating temperature of each power component is proportional to the power loss of that component along with the local ambient temperature and airflow affecting it. In complex electronic systems, power devices are positioned in many locations dictated by the specific load devices they directly power and therefore experience highly varied local ambient temperatures and airflows. In addition, many systems operate without the presence of redundant power components, and therefore, failure of a single power component may cause loss of function for the intermediate bus architecture power system 900 and for the load system.

To achieve optimum system life and reliability, it is beneficial to operate each power component such that its internal devices achieve the largest possible margin between their actual operating temperature and their maximum temperature rating. It is possible to balance and minimize the individual power loss that each power component achieves by adjusting the switching frequency of each power component or the bus voltage V_{BUS}.

In one embodiment of the intermediate bus architecture power system 900, each power component employs (or at least critical power components employ) internal temperature measurement and reporting capability. This capability allows the decision engine optimizing controller 920 to optimize reliability and device lifetime by balancing or maximizing the temperature margin for each power component. This may be accomplished through changes to individual power device switching frequency or changes in the bus voltage V_{BUS} consistent with ensuring that the system has adequate operating margin to allow transitions to increased power levels.

When the bus voltage V_{BUS} is lowered for a constant total load power, the loss within the bus converter 905 increases while loss within a POL decreases to a greater extent and therefore, the total system loss decreases. However, the increased loss in the bus converter 905 will cause it to experience higher internal device temperature. So, depending upon the local ambient temperature and airflow affecting the power component, a different bus voltage V_{BUS} can achieve the best operating temperature margin for devices in the intermediate bus architecture power system 900. Other operating parameters (e.g., a switching frequency, an input or output current as well as an input or output voltage) may be of interest to control and optimize. This includes the coordination of switching frequencies in multiple POLs to eliminate beat frequencies or sub-harmonics between them, for example.

Another factor influenced by the bus voltage V_{BUS} is a hold-up time provided by the intermediate bus capacitance C_{IB} used to store energy for the intermediate bus 910. This stored energy is proportional to the square of the bus voltage V_{BUS} times the value of the intermediate bus capacitance C_{IB}. The stored energy is used to provide power to the POLs 915₁, 915₂, . . . , 915_{N} during the hold-up time when the input voltage V_{INPUT} to the bus converter 905 is disrupted. When the bus voltage V_{BUS} is reduced for efficiency optimization, the stored energy is also reduced by a greater amount due to the squared voltage relationship. This may lead to unacceptable hold-up times for ride through during temporary interruptions of the input voltage V_{INPUT} to the bus converter 905 or insufficient time for a graceful system shutdown (allowing state and data retention, etc.) in response to an imminent system shutdown alarm signal, for example.

In a corresponding embodiment, the decision engine optimizing controller 920 causes the bus voltage V_{BUS} to be increased to a maximum bus voltage just before the operational disruption occurs. Increasing the bus voltage V_{BUS} to its maximum value insures that maximum energy is stored in the intermediate bus capacitance C_{IB} before the bus converter 905 is no longer able to maintain the bus voltage V_{BUS}. This allows a smaller value of the intermediate bus capacitance C_{IB} to be used than would otherwise be required if the bus voltage V_{BUS} remained at a lower value just prior to interruption or shutdown.

As previously mentioned, the decision engine optimizing controller 920 may employ other approaches to optimize an efficiency in addition to controlling the bus voltage V_{BUS}. Many power stages employ switching field effect transistors (FETs) connected in parallel. Losses associated with a gate drive of this parallel configuration may exceed the reduction in loss provided by a lower conduction or activation resistance. The decision engine optimizing controller 920 may monitor the POLs 915₁, 915₂, . . . , 915_{N}, for example, by sensing their individual output currents, and issue commands to deactivate a corresponding gate drive in ones of the POLs 915₁, 915₂, . . . , 915_{N} that are operating at a light load. The decision engine optimizing controller 920 may also disable a phase employed in multi-phase POLs.

FIG. 10 illustrates a block diagram of yet another embodiment of an intermediate bus architecture power system, generally designated 1000, constructed according to the principles of the present disclosure. The intermediate bus architecture power system 1000 includes a bus converter 1005, employing a bus connection 1006, that converts an input voltage V_{INPUT} into a bus voltage V_{BUS} on an intermediate bus 1010 having an intermediate bus capacitance C_{IB} connected as shown. The intermediate bus architecture power system 1000 also includes a plurality of POL converters (POLs) 1015₁, 1015₂, . . . , 1015_{N} employing individual POL controllers 1, 2, . . . , N and having inputs connected to the intermediate bus 1010 that supplies a corresponding plurality of output voltages V_{O1}, V_{O2}, . . . , V_{ON} from the bus voltage V_{BUS}.

The intermediate bus architecture power system 1000 further includes a decision engine optimizing controller 1020, coupled to the bus converter 1005 and the plurality of POLs 1015₁, 1015₂, . . . , 1015_{N}, that controls a system variable to improve overall system performance based on a monitored system variable or system constraint. Additionally, the intermediate bus architecture power system 1000 includes a data and control bus 1025, a power interface module 1030 connected to a voltage source V_{SOURCE} to provide the input voltage V_{INPUT} and a global system controller 1035 that is coupled to the decision engine optimizing controller 1020.

As before, the bus connection 1006 provides a controllable connection of the bus converter 1005 to the intermediate bus 1010. The bus connection 1006 consists of one or a plurality of parallel switches (e.g., FETs) wherein each switch is separately controllable to allow modification of a switch resistance for the plurality of parallel switches. Alternatively, the bus connection 1006 may include a simple low impedance soldered or connectorized connection to improve system efficiency.

In the illustrated embodiment, the data and control bus 1025 is connected between constituent parts of the intermediate bus architecture power system 1000 to allow data and control signal transfer between at least a portion of the constituent parts. Here, data and control signals are integrated into the data and control bus 1025. Alternately, the data and control signals may employ separate busses in other embodiments.

Also, the purpose of the power interface module 1030 in the intermediate bus architecture power system 1000 is to condition the source voltage V_{SOURCE} (e.g., to provide filtering of electromagnetic interference, handling of dual source voltage feeds or boosting of the input voltage V_{INPUT} to facilitate ride through) before it is fed to the bus converter 1005.

The decision engine optimizing controller 1020 provides local system control of the constituent parts that are controllable through the data and control bus 1025. Correspondingly, the global system controller 1035 may be a more general or hierarchical controller that provides supervisory and overriding control of the intermediate bus architecture power system 1000. Each of the plurality of POL controllers 1015₁, 1015₂, . . . , 1015_{N} provides unit control of its respective POL converter 1, 2, . . . , N, often under the influence of the decision engine optimizing controller 1020 or the global system controller 1035 through the data and control bus 1025.

In this arrangement, the decision engine optimizing controller 1020 is able to access data on one or more of the POLs 1015₁, 1015₂, . . . , 1015_{N} including static information such as its type or model along with and its operational characteristics. Additionally, real time operating information (e.g., its current load, output voltage, etc.) may also be accessible. This information, or portions thereof, can then be sent by the decision engine optimizing controller 1020 to a corresponding POL controller for use in determining and setting its maximum efficiency operating point.

For example, the decision engine optimizing controller 1020 may signal one of the POL controllers 1, 2, . . . , N that conditions are such that a multi-phase POL can operate with one or more phases disabled. The POL controller can then determine from its stored data or through the data and control bus 1025 if it will operate more efficiently with disabled phases. In this case, the one of the POL controllers 1, 2, . . . , N can instruct its corresponding POL to disable a phase.

Alternatively, a POL controller can notify the decision engine optimizing controller 1020 that disabling a phase provides better efficiency, and the decision engine optimizing controller 1020 can command the POL controller to disable a phase. After receiving this command, the POL controller may also utilize an algorithm that permits disabling the phase. An operating efficiency can be determined by this action and further improvement may be achieved by varying the bus voltage V_{BUS}.

If the new operating efficiency is higher than before the phase was disabled, the POL controller will cause that phase to remain disabled as long as permitted by the decision engine optimizing controller 1020. Of course, other POL characteristics may be utilized to disable one or more phases of the POL. Examples include disabling FETS operating in parallel as mentioned above or varying the operating frequency of the POL. It may also include adjusting the output voltage of the POL to a value within an acceptable range that results in increased efficiency.

A POL controller may power down its corresponding POL if it is determined that its output is unloaded. Additionally, a POL controller may autonomously recognize or receive signals from the decision engine optimizing controller 1020 or the global system controller 1035 that a “light load” or “sleep” state may be activated for its corresponding POL. Alternately, the decision engine optimizing controller 1020 or the global system controller 1035 may initiate commands to an appropriate POL controller to enter into a low power state or shutdown mode when it is possible to do so and still meet system operating requirements. The decision engine optimizing controller 1020 or the global system controller 1035 may then signal the POL controller, with sufficient advance notice, that particular POL outputs will be required again and the appropriate POLs can be reactivated to deliver needed power.

A required time to reactivate each POL can be stored in the decision engine optimizing controller 1020, the global system controller 1035 or appropriate POL controllers. The time to reactivate may be a constant for all POLs or different for one or more POL depending on operating conditions, for example. Use of this information ensures sufficient reactivation time is employed for each POL. This general type of control is applicable with either regulated or unregulated bus converter schemes.

There may be certain times or system operating modes when the intermediate bus architecture power system 1000 is placed into a low power sleep mode. For example, the intermediate bus architecture power system 1000 may go into a sleep mode at a particular time of day. During the sleep mode, the bus converter 1005 and the POLs 1015₁, 1015₂, . . . , 1015_{N} enter a low power state where, for example, the bus voltage V_{BUS} is a minimum voltage and the POLs 1015₁, 1015₂, . . . , 1015_{N} are operating in a light load state.

FIG. 11 illustrates a block diagram of still another embodiment of an intermediate bus architecture power system, generally designated 1100, constructed according to the principles of the present disclosure. The intermediate bus architecture power system 1100 includes a bus converter 1105, employing a bus connection 1106, that converts an input voltage V_{INPUT} into a bus voltage V_{BUS} on an intermediate bus 1110 having an intermediate bus capacitance C_{IB} connected as shown. The intermediate bus architecture power system 1100 also includes a plurality of POL converters (POLs) 1115₁, 1115₂, . . . , 1115_{N}, having inputs connected to the intermediate bus 1110, that supplies a corresponding plurality of output voltages V_{O1}, V_{O2}, . . . , V_{ON} from the bus voltage V_{BUS}.

The intermediate bus architecture power system 1100 further includes a decision engine optimizing controller 1120, coupled to the bus converter 1105 and the plurality of POL converters 1115₁, 1115₂, . . . , 1115_{N} that controls a system variable to improve overall system performance based on a monitored system variable or system constraint.

Additionally, the intermediate bus architecture power system 1100 includes a data and control bus 1125, a power interface module 1130 connected to a voltage source V_{SOURCE} to provide the input voltage V_{INPUT}, a global system controller 1135 that is coupled to the decision engine optimizing controller 1120 and a parallel bus converter 1145, employing a parallel bus connection 1146, that is parallel coupled with the bus converter 1105 to the intermediate bus 1110.

The bus connection 1106 and the parallel bus connection 1146 provide respective controllable connections of the bus converter 1105 and the parallel bus converter 1145 to the intermediate bus 1110. The bus and parallel bus connections 1106, 1146, may for example, each consist of one or a plurality of parallel switches (e.g., FETs) wherein each switch is separately controllable to allow modification of a switch resistance for the plurality of parallel switches.

The data and control bus 1125 is connected between constituent parts of the intermediate bus architecture power system 1100 to allow data transfer and control signaling between at least a portion of the constituent parts. Here, data and control signals are also integrated into the data and control bus 1125. Alternately, the data and control signals may employ separate busses in other embodiments. Again the purpose of the power interface module 1130 is to condition the source voltage V_{SOURCE} before it is fed to the bus and parallel bus converters 1105, 1145.

The decision engine optimizing controller 1120 provides local system control of the constituent parts that are controllable through the data and control bus 1125. The global system controller 1135 may be a more general controller or a hierarchical controller that provides supervisory and overriding control of the intermediate bus architecture power system 1100, as before.

The decision engine optimizing controller 1120 or the global system controller 1135 may provide separate or collective control of the plurality of parallel switches (e.g., FETs) in the modification of switch conductance of the bus and parallel bus connections 1106, 1146. For example, one or more of the plurality of parallel switches may be open during light load conditions. Additionally, one of the bus and parallel bus converters 1105, 1145 may be electrically disconnected from the intermediate bus 1110 during light load conditions. As discussed earlier, this may need to be done in a manner that accounts for intermediate bus hold-up time (intermediate bus capacitance C_{IB} energy storage) and start-up characteristics of the reactivated bus converter. In one embodiment of the intermediate bus architecture power system 1100, portions of the decision engine optimizing controller 1120 that control the plurality of parallel switches in the modification of the switch resistance of the bus and parallel bus connections 1106, 1146 may reside in the bus converter 1105 and the parallel bus converter 1145.

The decision engine optimizing controller 1120 may regulate each of the bus and parallel bus converters 1105, 1145 such that they share a total load current supplied to the intermediate bus 1110 equally or in a proportion that yields a higher overall system power efficiency while delivering a required bus voltage V_{BUS}. These load sharing characteristics may be constrained by predetermined limits to meet other power system needs such as transient load capability and step loads. In one embodiment, these limiting or paralleling conditions may be determined by the global system controller 1135 and provided to the decision engine optimizing controller 1120, which may then provide regulation and control sharing of each of the bus and parallel bus converters 1105, 1145.

This may be accomplished by measuring an output current by direct or indirect means. Indirect means may include measuring the currents in pertinent switching transistors and calculating the output current using stored data such as the transformer turns ratio, duty cycle, etc. The decision engine optimizing controller 1120 may have preset limits on allowable output voltage or duty cycle excursions around a particular operating condition to limit voltage swings in the intermediate bus 1110 during transient conditions.

The bus and parallel bus converters 1105, 1145 may be a mix of regulated and unregulated types. The decision engine optimizing controller 1120 can modify an output voltage of the regulated bus converter to match, be less than or higher than the unregulated bus converter. This condition may achieve higher overall efficiency for the intermediate bus architecture power system 1100 since it may utilize the inherent higher efficiency of an unregulated bus converter and the control capabilities of a regulated bus converter.

Under some circumstances an optimum efficiency point may exist where the decision engine optimizing controller 1120 sets the output of the regulated bus converter so that there is equal or proportional load sharing between the two bus converters 1105, 1145. If a maximum efficiency point requires a bus voltage that is lower than that supplied by the unregulated bus converter and the regulated bus converter itself is capable of supplying the current load, the decision engine optimizing controller 1120 may open the unregulated bus converter's bus connection or cause it to shutdown.

FIG. 12 illustrates a flow diagram of an embodiment of a method of operating an intermediate bus architecture power system, generally designated 1200, carried out according to the principles of the present disclosure. The method 1200 starts in a step 1205, and an input voltage is converted into a bus voltage on an intermediate bus in a step 1210. Then, in a step 1215, the bus voltage on the intermediate bus is converted into an output voltage by a point-of-load converter, and in a step 1220, a system variable is controlled to improve overall system performance based on a monitored system variable or a system constraint.

In one embodiment, controlling the system variable includes a conditioning of the input voltage where this conditioning includes filtering of electromagnetic interference (EMI), providing multiple feeds for the input voltage or increasing a value of the input voltage to facilitate ride through conditions.

In another embodiment, controlling the system variable includes internally controlling or externally controlling a bus converter that provides the bus voltage, where internally controlling is defined as a control function that is embedded within the bus converter and externally controlling is defined as a control function that is outside the bus converter. In either case, a bus voltage connection of the bus converter to the intermediate bus may be employed. Alternately, controlling the system variable includes controlling a plurality of parallel bus converters that provide the bus voltage where, in one example, at least one of the plurality of parallel bus converters is an unregulated bus converter. Additionally, controlling the system variable includes controlling a point-of-load converter that provides the output voltage. Also, controlling the system variable may include controlling a plurality of point-of-load converters.

In yet another embodiment, controlling the system variable includes communicating with a resource external to the system where the resource may be an external system controller. Additionally, controlling the system variable includes employing test, model number or serial number data where the test, model number or serial number data may be stored data or real time data. Alternately, controlling the system variable includes controlling a change to the system variable in a step-wise manner where the step-wise manner may employ a variable step size. Also, controlling the system variable includes controlling a slew rate of change to the system variable.

In still another embodiment, controlling the system variable includes selecting the system variable from the group consisting of a bus voltage on the intermediate bus, an output voltage, a control signal switching frequency or phase, a control signal activation time or period and a number of controlled devices activated. Additionally, controlling the system variable includes selecting the monitored system variable from the group consisting of a bus current supplied to the intermediate bus, a point-of-load converter output current, a power dissipation of a system device, an efficiency of a system device, a temperature of a system device, an electromagnetic interference (EMI) of a system device, a voltage ripple or current ripple of a system device, a transient response of a system device and a response to an actively generated system perturbation.

In a further embodiment, controlling the system variable includes selecting the system constraint from the group consisting of a preset constraint, a user-defined constraint, an in situ constraint and an adaptive constraint. Additionally, controlling the system variable includes controlling the system variable based on an alarm signal where, in one example, the alarm signal may indicate that a system shutdown is imminent.

In a still further embodiment, controlling the system variable includes employing a communications capability for the system. Additionally, the communications capability conforms to one selected from the group consisting of an Inter-Integrated Circuit (I²C) bus specification, a Controller-Area Network (CAN) bus specification and a Serial Peripheral Interface (SPI) bus specification. Also, the communications capability may employ wired, wireless or optical elements. Furthermore, the intermediate bus may be employed as the communications capability. The method 1200 ends in a step 1225.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

What is claimed is:

1. An intermediate bus architecture power system, comprising:
a bus converter that converts an input voltage into a bus voltage on an intermediate bus;
a point-of-load converter that supplies an output voltage from the bus voltage on the intermediate bus; and
a decision engine optimizing controller that controls a system variable to improve an overall system performance based on a monitored system variable or a system constraint.

2. The system as recited in claim 1 wherein the decision engine optimizing controller is selected from the group consisting of:
a controller embedded within the bus converter; and
a controller separate from the bus converter.

3. The system as recited in claim 1 wherein the decision engine optimizing controller is coupled to an intermediate bus connection of the bus converter.

4. The system as recited in claim 1 wherein the decision engine optimizing controller is coupled to a plurality of point-of-load converters to control the system variable.

5. The system as recited in claim 1 wherein the decision engine optimizing controller communicates with another controller to control the system variable.

6. The system as recited in claim 1 wherein the decision engine optimizing controller employs test, model number or serial number data in controlling the system variable.

7. The system as recited in claim 6 wherein the test, model number or serial number data are stored data.

8. The system as recited in claim 1 wherein the decision engine optimizing controller controls a change to the system variable in a step-wise manner.

9. The system as recited in claim 8 wherein the step-wise manner employs a variable step size.

10. The system as recited in claim 1 wherein the decision engine optimizing controller controls a slew rate of change to the system variable.

11. The system as recited in claim 1 wherein the system variable is selected from the group consisting of:
the bus voltage on the intermediate bus;
the output voltage;
a control signal switching frequency or phase;
a control signal activation time or period; and
a number of controlled devices activated.

12. The system as recited in claim 1 wherein the monitored system variable is selected from the group consisting of:
a bus current supplied to the intermediate bus;
an output current supplied by the point-of-load converter;
a power dissipation of a system device;
an efficiency of a system device;
a temperature of a system device;
an electromagnetic interference (EMI) of a system device;
an output voltage or current ripple of a system device;
a transient response of a system device; and
a response to an actively generated system perturbation.

13. The system as recited in claim 1 wherein the system constraint is selected from the group consisting of:
a preset constraint;
a user-defined constraint;
an in situ constraint; and
an adaptive constraint.

14. The system as recited in claim 1 wherein the system constraint is based on an alarm signal.

15. The system as recited in claim 14 wherein the alarm signal indicates that a system shutdown is imminent.

16. The system as recited in claim 1 further comprising a communications bus that couples the decision engine optimizing controller to a system element.

17. The system as recited in claim 16 wherein the communications bus is connected to provide data transfer between the decision engine optimizing controller and the system element.

18. The system as recited in claim 16 wherein the communications bus is connected to provide control signals between the decision engine optimizing controller and the system element.

19. The system as recited in claim 16 wherein the communications bus conforms to one selected from the group consisting of:
an Inter-Integrated Circuit (I²C) bus specification;
a Controller-Area Network (CAN) bus specification; and
a Serial Peripheral Interface (SPI) bus specification.

20. The system as recited in claim 16 wherein the communications bus employs wired, wireless or optical elements.

21. The system as recited in claim 16 wherein the intermediate bus is employed as the communications bus.

22. The system as recited in claim 1 further comprising a power interface module that provides a conditioning of the input voltage.

23. The system as recited in claim 22 wherein the conditioning of the input voltage includes one selected from the group consisting of:
filtering of electromagnetic interference (EMI);
providing multiple feeds for the input voltage; and
increasing a value of the input voltage to facilitate ride through conditions.

24. The system as recited in claim 1 further comprising a parallel bus converter that converts an input voltage into the bus voltage on the intermediate bus.

25. The system as recited in claim 24 wherein the decision engine optimizing controller is coupled to the parallel bus converter to control the system variable.

26. The system as recited in claim 25 wherein the decision engine optimizing controller is coupled to a parallel intermediate bus connection of the parallel bus converter.

27. The system as recited in claim 24 wherein the parallel bus converter is an unregulated bus converter.

28. A method of operating an intermediate bus architecture power system, comprising:
converting an input voltage into a bus voltage on an intermediate bus;
converting the bus voltage on the intermediate bus to an output voltage; and
controlling a system variable to improve overall system performance based on a monitored system variable or a system constraint.

29. The method as recited in claim 28 wherein controlling the system variable includes one selected from the group consisting of:
internally controlling a bus converter that supplies the bus voltage; and
externally controlling a bus converter that supplies the bus voltage.

30. The method as recited in claim 28 wherein controlling the system variable includes controlling a bus voltage connection of a bus converter to the intermediate bus.

31. The method as recited in claim 28 wherein controlling the system variable includes controlling a plurality of parallel bus converters that provide the bus voltage.

32. The method as recited in claim 31 wherein at least one of the plurality of parallel bus converters is an unregulated bus converter.

33. The method as recited in claim 28 wherein controlling the system variable includes controlling a point-of-load converter that provides the output voltage.

34. The method as recited in claim 28 wherein controlling the system variable includes controlling a plurality of point-of-load converters.

35. The method as recited in claim 28 wherein controlling the system variable includes communicating with a resource external to the system.

36. The method as recited in claim 35 wherein the resource is an external system controller.

37. The method as recited in claim 28 wherein controlling the system variable includes employing test, model number or serial number data.

38. The method as recited in claim 37 wherein the test, model number or serial number data are stored data.

39. The method as recited in claim 28 wherein controlling the system variable includes controlling a change to the system variable in a step-wise manner.

40. The method as recited in claim 39 wherein the step-wise manner employs a variable step size.

41. The method as recited in claim 28 wherein controlling the system variable includes controlling a slew rate of change to the system variable.

42. The method as recited in claim 28 wherein controlling the system variable includes selecting the system variable from the group consisting of:
the bus voltage on the intermediate bus;
the output voltage;
a control signal switching frequency or phase;
a control signal activation time or period; and
a number of controlled devices activated.

43. The method as recited in claim 28 wherein controlling the system variable includes selecting the monitored system variable from the group consisting of:
a bus current supplied to the intermediate bus;
a point-of-load converter output current;
a power dissipation of a system device;
an efficiency of a system device;
a temperature of a system device;
an electromagnetic interference (EMI) of a system device;
a voltage ripple or current ripple of a system device;
a transient response of a system device; and
a response to an actively generated system perturbation.

44. The method as recited in claim 28 wherein controlling the system variable includes selecting the system constraint from the group consisting of:
a preset constraint;
a user-defined constraint;
an in situ constraint; and
an adaptive constraint.

45. The method as recited in claim 28 wherein controlling the system variable includes controlling the system variable based on an alarm signal.

46. The method as recited in claim 45 wherein the alarm signal indicates that a system shutdown is imminent.

47. The method as recited in claim 28 wherein controlling the system variable includes employing a communications capability for the system.

48. The method as recited in claim 47 wherein the communications capability conforms to one selected from the group consisting of:
an Inter-Integrated Circuit (I²C) bus specification;
a Controller-Area Network (CAN) bus specification; and
a Serial Peripheral Interface (SPI) bus specification.

49. The method as recited in claim 47 wherein the communications capability employs wired, wireless or optical elements.

50. The method as recited in claim 47 wherein the intermediate bus is employed as the communications capability.

51. The method as recited in claim 28 wherein controlling the system variable includes a conditioning of the input voltage.

52. The method as recited in claim 51 wherein the conditioning of the input voltage includes one selected from the group consisting of:
filtering of electromagnetic interference (EMI);
providing multiple feeds for the input voltage; and
increasing a value of the input voltage to facilitate ride through conditions.
